(19) United States
(12) Patent Application Publication
(10) Pub. No.: US 2008/0194407 A1
(43) Pub. Date: Aug. 14, 2008

(54) High nitrogen containing chelate compositions suitable for plant delivery

(76) Inventors: H. DeWayne Ashmead, Fruit Heights, UT (US); Stephen D. Ashmead, West Haven, UT (US)

Correspondence Address: THORPE NORTH & WESTERN, LLP., P.O. Box 1219, SANDY, UT, 84091-1219, US

(21) Appl. No.: 11/706,870

(22) Filed: Feb. 14, 2007

(51) Int. Cl. A01N 55/02; A01P 21/00

(52) U.S. Cl. 504/126

(57) ABSTRACT

The present invention is directed to methods and compositions which include high nitrogen metal amino acid chelates that can increase the metabolic activity or metal concentration in plants. In one embodiment, an amino acid composition can comprise an amino acid chelate with a first metal and first amino acid ligand, where the first amino acid ligand has at least two nitrogen atoms, and an amino acid complex different from the amino acid chelate having a second metal and second amino acid ligand. The amino acid composition can also include nitrogen salts, proteinates, urea, nitric acid, ammonium nitrate, hydrolyzed animal sourced or plant sourced proteins, and combinations thereof.

### FIELD OF THE INVENTION

The present invention is drawn to methods and compositions with high nitrogen-containing chelates. Additionally, the present invention is drawn to the use of high nitrogen-containing amino acid chelates and other nitrogen containing compounds for increasing and/or retaining nitrogen and metal content within a plant tissue for enhancing metabolic activity.

### BACKGROUND OF THE INVENTION

Amino acid chelates are generally produced by the reaction between α-amino acids and metal ions having a valence of two or more to form a ring structure. In such a reaction, the positive electrical charge of the metal ion can be neutralized by the electrons available through the carboxylate or free amino groups of the α-amino acid.

Traditionally, the term “chelate” has been loosely defined as a combination of a metallic ion bonded to one or more ligands to form a heterocyclic ring structure. Under this definition, chelate formation through neutralization of the positive charge(s) of the metal ion may be through the formation of ionic, covalent or coordinate covalent bonding. An alternative and more modern definition of the term “chelate” requires that the metal ion be bonded to the ligand solely by coordinate covalent bonds forming a heterocyclic ring. In either case, both are definitions that describe a metal ion and a ligand forming a heterocyclic ring.

Chelation can be confirmed and differentiated from mixtures of components or more ionic complexes by infrared spectra through comparison of the stretching of bonds or shifting of absorption caused by bond formation. As applied in the field of mineral nutrition, there are certain “chelated” products that are commercially utilized. The first is referred to as a “metal proteinate.” The American Association of Feed Control officials (AAFCO) has defined a “metal proteinate” as the product resulting from the chelation of a soluble salt with amino acids and/or partially hydrolyzed protein. Such products are referred to as the specific metal proteinate, e.g., copper proteinate, zinc proteinate, etc. Sometimes, metal proteinates are incorrectly referred to as amino acid chelates.

The second product, referred to as an “amino acid chelate,” when properly formed, is a stable product having one or more five-membered rings formed by a reaction between the amino acid and the metal. The American Association of Feed Control Officials (AAFCO) has also issued a definition for amino acid chelates. It is officially defined as the product resulting from the reaction of a metal ion from a soluble metal salt with amino acids having a mole ratio of one mole of metal to one to three (preferably two) moles of amino acids to form coordinate covalent bonds. The average weight of the hydrolyzed amino acids must be approximately 150 and the resulting molecular weight of the chelate must not exceed 800. The products are identified by the specific metal forming the chelate, e.g., iron amino acid chelate, copper amino acid chelate, etc.

In further detail with respect to amino acid chelates, the carboxyl oxygen and the α-amino group of the amino acid each bond with the metal ion. Such a five-membered ring is defined by the metal atom, the carboxyl oxygen, the carbonyl carbon, the α-carbon and the α-amino nitrogen. The actual structure will depend upon the ligand to metal mole ratio and whether the carboxyl oxygen forms a coordinate covalent bond or an ionic bond with the metal ion. Generally, the ligand to metal molar ratio is at least 1:1 and is preferably 2:1 or 3:1. However, in certain instances, the ratio may be 4:1. Most typically, an amino acid chelate with a divalent metal can be represented at a ligand to metal molar ratio of 2:1 according to Formula 1 as follows:

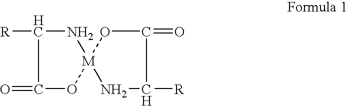

In the above formula, the dashed lines represent coordinate covalent bonds, covalent bonds, or ionic bonds. Further, when R is H, the amino acid is glycine, which is the simplest of the α-amino acids. However, R could be representative of any other side chain that, when taken in combination with the rest of the ligand structure(s), results in any of the other twenty or so naturally occurring amino acids derived from proteins. All of the amino acids have the same configuration for the positioning of the carboxyl oxygen and the α-amino nitrogen with respect to the metal ion. In other words, the chelate ring is defined by the same atoms in each instance, even though the R side chain group may vary.

With respect to both amino acid chelates and metal proteinates, the reason a metal atom can accept bonds over and above the oxidation state of the metal is due to the nature of chelation. For example, at the α-amino group of an amino acid, the nitrogen contributes to both of the electrons used in the bonding. These electrons fill available spaces in the d-orbitals forming a coordinate covalent bond. Thus, a metal ion with a normal valency of +2 can be bonded by four bonds when fully chelated. In this state, the chelate is completely satisfied by the bonding electrons and the charge on the metal atom (as well as on the overall molecule) is zero. As stated previously, it is possible that the metal ion can be bonded to the carboxyl oxygen by either coordinate covalent bonds or ionic bonds. However, the metal ion is preferably bonded to the α-amino group by coordinate covalent bonds only.

The structure, chemistry, bioavailability, and various applications of amino acid chelates are well documented in the literature, e.g. Ashmead et al., Chelated Mineral Nutrition, (1982), Chas. C. Thomas Publishers, Springfield, Ill.; Ashmead et al., Foliar Feeding of Plants with Amino Acid Chelates, (1986), Noyes Publications, Park Ridge, N.J.; U.S. Pat. Nos. 4,020,158; 4,167,564; 4,216,143; 4,216,144; 4,599,152; 4,725,427; 4,774,089; 4,830,716; 4,863,898; 5,292,538; 5,292,729; 5,516,925; 5,596,016; 5,882,685; 6,159,530; 6,166,071; 6,207,204; 6,294,207; and 6,614,553; each of which are incorporated herein by reference.

One advantage of amino acid chelates in the field of mineral nutrition is attributed to the fact that these chelates are readily absorbed by means of active transport into plant tissue. In other words, the minerals can be absorbed along with the amino acids as a single unit utilizing the amino acid(s) as a carrier molecule.

Even though chelation generally offers better mineral absorbability, absorption is a complex biological function influenced by many variables. As such methods and complexes with improved absorption characteristics that provide increased benefits continue to be sought through ongoing research and development efforts.

### SUMMARY OF THE INVENTION

Briefly, and in general terms, the invention is directed to methods and compositions that are formulated such that metals from amino acid chelates and other nitrogen-containing compounds, e.g., salts, etc., which are present can increase the metabolic activity and metal tissue concentration in a plant. In one embodiment, an amino acid chelate composition for plant nutrition can comprise an amino acid chelate including a first metal and a first amino acid ligand, wherein the first amino acid ligand has at least two nitrogen atoms. The composition can also include an amino acid complex including a second metal and a second amino acid ligand that is different than the amino acid chelate. These compounds are formulated in a vehicle or carrier which, along with the amino acid chelate and the amino acid complex, is suitable for delivery to a plant.

In another embodiment, an amino acid chelate composition for plant nutrition can comprise an amino acid chelate including a metal and an amino acid ligand having at least two nitrogen atoms, and a second nitrogen-containing compound selected from the group consisting of nitrogen-containing salts, proteinates, urea, nitric acid, ammonium nitrate, hydrolyzed animal sourced or plant sourced proteins, and combinations thereof. Also, a vehicle or carrier can be formulated, along with the amino acid chelate and the second nitrogen-containing compound, which is suitable for delivery to a plant.

In another embodiment, a method of increasing a metabolic activity in plant tissue can comprise delivering an amino acid chelate composition including an amino acid chelate having a multi-nitrogen-containing amino acid ligand and a metal to a plant. The delivery can be in an amount sufficient to i) raise the nitrogen and the metal concentration within the tissue, ii) retain metal content in the tissue for a greater period of time compared to when the metal is delivered as a compound with less nitrogen, and iii) enhance metabolic activity of the tissue.

Other embodiments will also be described herein which illustrate, by way of example, features of the present invention.

### DETAILED DESCRIPTION OF THE PREFERRED EMBODIMENT(S)

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

It is noted that, as used in this specification and the appended claims, the singular forms “a,” “an,” and, “the” include plural referents unless the context clearly dictates otherwise. Thus, for example, reference to “a chelate” can include one or more of such chelates, reference to “an amount of nitrogen” can include reference to one or more amounts of nitrogen, and reference to “the amino acid” can include reference to one or more amino acids.

As used herein, the term “naturally occurring amino acid” or “traditional amino acid” shall mean amino acids that are known to be used for forming the basic constituents of proteins, including alanine, arginine, asparagine, aspartic acid, cysteine, cystine, glutamine, glutamic acid, glycine, histidine, hydroxyproline, isoleucine, leucine, lysine, methionine, ornithine, phenylalanine, proline, serine, threonine, tryptophan, tyrosine, valine, and combinations thereof.

As used herein, the term “nitrogen-containing” refers to any compound, molecule, complex, or chelate that contains a nitrogen atom. “High-nitrogen” refers to compounds where any single organic ligand of a compound has more than one nitrogen atom.

As used herein, the term “amino acid chelate” refers to both the traditional definitions and the more modern definition of chelate as cited previously, i.e. a chelate requires the presence of a ring structure. Specifically, with respect to chelates that utilize traditional amino acid ligands, i.e., those used in forming proteins, chelate is meant to include metal ions bonded to proteinaceous ligands forming heterocyclic rings. Between the carboxyl oxygen and the metal, the bond can covalent or ionic, but is preferably coordinate covalent. Additionally, at the α-amino group, the bond is typically a coordinate covalent bond. Proteinates of naturally occurring amino acids are included in this definition. As used herein, the term “amino acid chelate” and “metal amino acid chelate” are used interchangeable, as by definition, a chelate requires the presence of a metal.

As used herein, the term “metal” refers to nutritionally relevant metals including divalent and trivalent metals which are beneficial to plants, and are substantially non-toxic when delivered in traditional amounts, as is known in the art. Examples of such metals include copper, zinc, manganese, iron, calcium, potassium, sodium, magnesium, cobalt, nickel, molybdenum, and the like. This term also includes nutritional semi-metals, such as, but not limited to, silicon and boron.

In certain embodiments, in addition to more traditional “metals” and “semi-metals,” that can be chelated or complexed with various ligands, ions such as monovalent metals or phosphorus can also be included in compounds in accordance with embodiments of the present invention.

As used herein, the term “proteinate” when referring to a metal proteinate is meant to include compounds where the metal is chelated or complexed to hydrolyzed or partially hydrolyzed protein forming a heterocyclic ring. Coordinate covalent bonds, covalent bonds, and/or ionic bonds may be present between the metal and the proteinaceous ligand of the chelate or chelate/complex structure. As used herein, proteinates are included when referring to amino acid chelates. However, when a proteinate is specifically mentioned, it does not include all types of amino acid chelates, as it only includes those with hydrolyzed or partially hydrolyzed protein.

As used herein, the term “complex” generally refers to molecules formed by the combination of ligands and metal ions. This term includes complexes formed by coordinate, coordinate covalent, and ionic bonds, and does not require a ring structure.

As used herein, the term “about” is used to provide flexibility to a numerical range endpoint by providing that a given value may be “a little above” or “a little below” the endpoint.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 micron to about 5 microns” should be interpreted to include not only the explicitly recited values of about 1 micron to about 5 microns, but also include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

With these definitions in mind, it has been discovered that high nitrogen-containing metal amino acid chelates can increase metabolic activity in a plant as well as mineral retention in plant tissue. Specifically, it has been found that high nitrogen-containing metal amino acid chelates have an unexpected effect on the metabolic activity of various plants due to the increased metal retention. Generally, the high nitrogen-containing metal amino acid chelates can increase the mineral concentration in the plant tissue over a longer period of time. For example, in fruiting plants, metabolic activity such as fruit storability, plant growth, fruit growth rates, and production can be increased by such administration more so than by delivering other compounds with less nitrogen.

In one embodiment, an amino acid chelate composition for plant nutrition can comprise an amino acid chelate including a first metal and a first amino acid ligand, wherein the first amino acid ligand has at least two nitrogen atoms. The composition can also include an amino acid complex including a second metal or other ion and a second amino acid ligand that is different than the amino acid chelate. These compounds are formulated in a vehicle or carrier which, along with the amino acid chelate and the amino acid complex, is suitable for delivery to a plant. The difference between the chelate and the complex can be due to the differences in the metals or other ions, ligands, or chemical structure, where the structures can have a different spatial orientation or different bonding types. In one embodiment, the metals are different and the amino acid ligands are the same. In another embodiment, the metals are the same while the amino acids are different. In still another embodiment, both the metals and the ligands are different. It is noted that in one embodiment, the amino acid complex can be a second amino acid chelate. The amino acids used in the present invention can be sourced from fermentation processes or from synthetic processes.

In another embodiment, an amino acid chelate composition for plant nutrition can comprise an amino acid chelate including a metal and an amino acid ligand having at least two nitrogen atoms, and a second nitrogen-containing compound selected from the group consisting of nitrogen-containing salts, proteinates, urea, nitric acid, ammonium nitrates, hydrolyzed animal sourced or plant sourced proteins, and combinations thereof. Also, a vehicle or carrier can be formulated, along with the amino acid chelate and the second nitrogen-containing compound, which is suitable for delivery to a plant.

In another embodiment, a method of increasing a metabolic activity in plant tissue can comprise delivering an amino acid chelate composition including an amino acid chelate having a multi-nitrogen-containing amino acid ligand and a metal to a plant. The delivery can be in an amount sufficient to i) raise the nitrogen and the metal concentration within the tissue, ii) retain metal content in the tissue for a greater period of time compared to when the metal is delivered as a compound with less nitrogen, and iii) enhance metabolic activity of the tissue.

In accordance with the above embodiments, it is noted that further detail with respect to each of the above will be discussed to provide various embodiments of the present invention. It should be noted, however, that discussion of details from one embodiment is applicable to other embodiments. As such, further detail related to these embodiments will generally be discussed together.

Generally, the amino acid chelate compositions can include a high nitrogen amino acid chelate as well as other compounds, e.g., a second amino acid complex and/or a high nitrogen compound. The high nitrogen amino acid chelates can include amino acid ligands such as, but not limited to, arginine, asparagine, glutamine, histidine, lysine, ornithine, cystine, and tryptophan, including dipeptides, tripeptides, and tetrapeptides thereof. Specifically, a high nitrogen amino acid chelate contains at least one amino acid ligand that has at least two nitrogen atoms. In one embodiment, a high nitrogen amino acid chelate contains at least one amino acid ligand that has at least three nitrogen atoms. In another embodiment, a high nitrogen amino acid chelate contains at least one amino acid ligand that has at least four nitrogen atoms.

The amino acid complex, if present, can be a non-chelated complex, or alternatively, a second amino acid chelate. In one embodiment, the second amino acid chelate can include an amino acid ligand such as, but not limited to, alanine, arginine, asparagine, aspartic acid, cysteine, cystine, glutamine, glutamic acid, glycine, histidine, hydroxyproline, isoleucine, leucine, lysine, methionine, ornithine, phenylalanine, proline, serine, threonine, tryptophan, tyrosine, and valine, including dipeptides, tripeptides, and tetrapeptides thereof. In another embodiment, the second amino acid chelate can contain at least one amino acid ligand having at least two nitrogen atoms. Alternatively, the amino acid complex can be a non-chelate complex where anionic counterion can be, for example, a nitrate, an amino acid (complex form), or a ureate.

In some embodiments, a second nitrogen-containing compound can be used instead of or in addition to the amino acid complex, e.g., nitrogen-containing salts, proteinates, urea, nitric acid, ammonium nitrate, hydrolyzed animal sourced or plant sourced proteins, etc. In one embodiment, the second nitrogen-containing compound can include at least one nitrogen atom, but can include at least two nitrogen atoms, or even at least three nitrogen atoms.

In any of these embodiments, the metals or other ions contemplated for use in the compositions and methods of the present invention are generally nutritionally relevant metals or other ions, as defined previously. Specific examples include, but are not limited to, copper, zinc, manganese, iron, calcium, potassium, phosphorous, boron, sodium, silicon, magnesium, cobalt, nickel, molybdenum, and the like. It is noted that certain metals or other ions may perform better for certain targeted metabolic activity. For example, if the desire is to enhance general growth, metals such as zinc, calcium, and/or magnesium may be preferable for use in the amino acid chelate and/or the amino acid complex (which may optionally also be a chelate). If the desire is to enhance fruit production, metals such as zinc, manganese, and/or iron may be preferable for use in the amino acid chelate and/or the amino acid complex (which may also optionally also be a chelate). If the desire is to enhance plant quality, metals or other ions such as calcium and/or potassium may be preferable for use in the amino acid chelate and/or the amino acid complex (which may also optionally also be a chelate). Other metabolic activities and metal choices may be determined by one skilled in the art.

An amino acid chelate composition can include numerous combinations of metals to ligands in the form of chelates and other compounds and complexes. Such arrangements are contemplated by the present invention and may be manufactured through generally known preparative complex and/or chelation methods. It is not the purpose of the present invention to describe how to prepare amino acid chelates that can be used with the present invention. Suitable methods for preparing such amino acid chelates can include those described in U.S. Pat. Nos. 4,830,716 and/or 5,516,925, to name a few. However, combinations of such chelates as part of a composition for increasing metabolic activity or increasing and retaining nitrogen and metal content in a tissue are included as an embodiment of the present invention. In one embodiment, the first amino acid chelate and the second amino acid complex each have an amino acid ligand to metal or other ion ratio from about 1:1 to about 4:1. In another embodiment, the amino acid chelate composition has an amino acid chelate to amino acid complex ratio from about 10:1 to about 1:10, by weight.

In this and other embodiments, the amino acid chelate composition can include an additional third nitrogen-containing compound. The third nitrogen-containing compound can be, but is not limited to, proteinates, urea, nitric acid, ammonium, hydrolyzed animal sourced or plant sourced proteins, and combinations thereof. The amino acid chelate composition can also include a third compound that preferably is also a nitrogen-containing compound, e.g., chelate, complex, or salt, including a third metal or other ion and an anionic counterion or coordination ligand. The third metal or other ion can be any metal as previously defined. The third metal or other ion may be the same as, or different than, the first and/or second metals or other ions. Specifically, all three metals including other ions may be the same, all may be different, or 2 metals may be the same with the third metal being different. The anionic counterion or coordination ligand can be, for example, another amino acid chelate or complex; proteins; peptides, polypeptides; amino acid sulfates; nitrates; cyano-compounds; soy isolate or hydrolyzed soy protein; hydrolyzed feather meal; albumin; casine; urea; whey; gelatin; or ammonium compounds. In each of these embodiments, the third compound can also be a nitrogen-containing compound including 1 nitrogen atom, 2 nitrogen atoms, 3 nitrogen atoms, or even 4 nitrogen atoms.

Additional ingredients that can be used that are good sources of nitrogen include hydrolyzed blood meal, hydrolyzed manure, hydrolyzed fish emulsions, e.g., pureed fish, worm castings, hydrolyzed alfalfa meal, and/or hydrolyzed cotton seed meal.

In each of the above-described embodiments, the compositions and methods of the present invention can provide nitrogen content to a plant from about 0.5 wt % to about 35 wt %, based on the composition as a whole. Additionally, the compositions and methods of the present invention can provide nitrogen content to a plant from about 5 wt % to about 35 wt %, based solely on the nitrogen-containing compounds of the composition. Also as mentioned, in certain embodiments, the enhanced metabolic activity can be faster growth, greater production, or improved storability of fruit. The compositions for administration can be formulated for root, seed, or foliar delivery. Administration can also be formulated for delivery to the fruit via immersing the fruit in an amino acid solution to increase storability.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

### EXAMPLES

The following provides examples of high nitrogen amino acid compositions in accordance with the compositions and methods previously disclosed. Additionally, some of the examples include studies performed showing the effects of high nitrogen metal amino acid chelates on plants in accordance with embodiments of the present invention.

### Example 1

To about 700 ml of deionized water containing 50 grams citric acid is added 616 grams of arginine to form a clear solution. To this solution of citric acid and arginine is slowly added 55.8 grams of elemental iron. The solution is heated at about 50° C. for 48 hours, or until substantially all the iron is observed to go into solution. The product can remain as a solution, or alternatively, cooled, filtered, and spray dried. The resulting product is a ferric trisarginate amino acid chelate.

### Example 2

A copper carbonate solution is prepared by adding 6.1 parts by weight of cupric carbonate to 80.9 parts by weight water. This solution is allowed to stand without agitation for about two hours. To this solution is added 16.4 parts by weight of asparagine, and the mixture is slowly stirred for about two more hours. To the hazy solution is added 65 parts by weight of a 15 wt % citric acid solution and the mixture is stirred until a clear solution is observed. The product can remain as a solution, or alternatively, spray dried to form a powder. The resulting product is a copper bisasparaginate powder.

### Example 3

A solution is prepared including 10.1 parts by weight of histidine dissolved in 82.2 parts by weight water containing 1.0 part by weight sodium carbonate. To this solution is added 4.4 parts by weight zinc oxide. The molar ratio of histidine to zinc is 2:1. The reaction mixture is allowed to stand for about 14 hours and turned an opalescent color. After standing, the mixture is heated to about 70° C. can be spray dried to obtain a zinc bishistidinate amino acid chelate powder.

### Example 4

5 About 250 grams of glycine is dissolved into 937.8 grams of water. Once the glycine is significantly dissolved, about 95 grams of calcium oxide is added. The solution is continually stirred for about 15 minutes until all of the calcium is dissolved. The reaction mixture is heated to about 50° C. to 55° C. and can be spray dried providing a calcium bisglycinate powder.

### Example 5

A mixture of 42.93 grams of zinc sulfate, 67 grams of lysine, and 30 grams of glycine are reacted in an aqueous environment for 60 minutes at a temperature of about 65 to 70° C. The reaction of the zinc sulfate, lysine, and glycine produces a zinc amino acid chelate having a ligand component to metal molar ratio of about 2:1, and a lysine to glycine molar ratio of about 1:1. This composition can remain as a liquid for liquid application, or can be spray dried for storage or use as a solid.

### Example 6

A high nitrogen amino acid composition is obtained by dissolving 106 grams of iron trisarginate powder of Example 1 with 31.2 grams of calcium bisglycinate powder of Example 4 in 500 ml of water, heating to about 50 to 55° C., and spray drying, forming a powder having an iron to calcium molar ratio of about 1:1 and an arginine to glycine molar ratio of about 3:2.

### Example 7

A high nitrogen amino acid chelate composition is obtained by dry blending 73 grams of the copper bisasparaginate of Example 2 with 85 grams of zinc bishistidinate of Example 3 to provide a homogenous amino acid composition with a copper to zinc molar ratio of about 1:1, and an asparagine to histidine molar ratio of about 1:1.

### Example 8

Various high nitrogen amino acid chelate compositions can be prepared by admixing at least two of the amino acid chelates prepared in accordance with Examples 1-7. The admixtures can be prepared by dry blending two or more of the particulate chelates, dissolving or dispersing each of the particulate chelates and then liquid blending them together, dry blending the chelates and then dissolving the dry blend in a liquid carrier, liquid blending without having first spray dried the compositions, etc. Appropriate molar ratios of any two compounds can be from about 10:1 to about 1:10.

### Example 9

Zinc nitrate is admixed with the one or more of the amino acid chelates of Examples 1-3 or 5-7 at a 1:5 to 5:1 molar ratio, resulting in a high-nitrogen amino acid chelate/zinc nitrate salt formulation.

### Example 10

Saltpeter (potassium nitrate) is admixed with one or more amino acid chelates of Examples 1-3 or 5-7 at a 1:10 to 10:1 molar ratio forming a dry powder that is used as a fertilizer for plants. The dry powder can also be admixed with water forming a foliar spray.

### Example 11

Hydrolyzed manure is admixed with one or more amino acid chelates of Examples 1-3 or 5-7 at a dry weight ratio of about 100:1 to about 1:1. The admixture is applied to the soil of various plants to improve overall plant quality.

### Example 12

Phosphorous pentoxide and diammonium phosphate are admixed at 10:1 to 1:10 molar ratios forming a granulated powder. The phosphate powder is admixed with one or more amino acid chelates of Examples 1-3 or 5-7 in a molar ratio of about 10:1 to 1:10, forming a dry solid. The admixture is applied to various plants increasing plant growth.

### Example 13

A blueberry study was conducted where plants were sprayed with various solutions containing calcium, zinc, and magnesium. The various metals were provided as either high nitrogen amino acid chelates or as inorganic soluble salts. When used as chelates, the high nitrogen amino acids were arginine, lysine, leucine, alanine, and glycine. In each case, three applications were applied once a month for three consecutive months. Table 1 summarizes the applications

TABLE 1
Foliar Applications of Ca, Zn and Mg

| | oz. applied | | oz. applied | | oz. applied | |
|---|---|---|---|---|---|---|
| | Ca/acre | | Zn/acre | | Mg/acre | |
| Month | Inorganic | AAC | Inorganic | AAC | Inorganic | AAC |
| 1 | 8.32 | 1.92 | 4.74 | 2.18 | — | — |
| 2 | 6.24 | 1.92 | 3.59 | — | — | 1.01 |
| 3 | 11.38 | 1.92 | — | — | 12.80 | — |
| Total | 25.94 | 5.76 | 8.33 | 2.18 | 12.80 | 1.01 |

At harvest, which is three weeks following the last foliar applications, blueberry samples were taken and analyzed by ICP for calcium, zinc and magnesium retention, Table 2 summarizes the results.

TABLE 2
Mineral Analysis of Blueberries

| | Ca (%) | Zn (ppm) | Mg (ppm) |
|---|---|---|---|
| AAC | 0.13 | 20 | 0.06 |
| Inorganic | 0.09 | 11 | 0.05 |

This data demonstrates that retention of calcium, zinc and magnesium in plant tissue was greater when the plants received minerals attached (in this case chelated) to high nitrogenous ligands. While significantly more of the inorganic sources of calcium, zinc and magnesium were applied to the blueberry plants over a 3 month period, the plants retained more calcium, zinc, and magnesium when the same minerals were applied as high nitrogen amino acid chelates, even when the application amounts were less.

It is noted that foliar sprays are applied to the leaves of the plants. The minerals from either source have to be translocated from the leaves to the berries following their development. It was discovered that more of the minerals from the high nitrogen amino acid chelate source was stored and subsequently translocated from the leaves to the blueberries.

### Example 14

A greenhouse foliar study was conducted in which 12 inch corn (maze) plants were sprayed with a solution that contained 400 ppm Fe as FeSO₄, Fe EDTA, or Fe high nitrogen amino acid chelate with and without the addition of urea and ammonium nitrate. The high nitrogen amino acids were lysine, histidine, cysteine, tryptophan, aspartic acid, alanine, and glycine. The urea and ammonium nitrate were formulated as an admixture and not reacted to the Fe sources. The nitrogen concentrations provided by the urea ammonium nitrate in the final solutions are 0 ppm, 500 ppm, and 1000 ppm nitrogen with half the nitrogen coming from urea and half from ammonium nitrate.

The various treatments were applied to the plants via a foliar spray when the plants had attained a height of 12 inches. These same treatments were repeated one week later. Three weeks following the last spray, all of the plants were harvested and the roots separated from the stalks. Each sample was dried for 24 hours at 75° C., then weighed for dry matter, and the Fe concentrations determined by plasma emission spectrophotometry. Table 3 shows the results of the iron assays.

TABLE 3
Fe in Leaves

| | 0 ppm N from urea | 500 ppm N from | 1000 ppm N urea |
|---|---|---|---|
| | and ammonium | urea and ammonium | and ammonium |
| | nitrate | nitrate | nitrate |
| FeSO₄ | 48 ppm^{a} Fe | 53 ppm^{a} Fe | 63 ppm^{a} Fe |
| Fe EDTA | 47 ppm^{a} Fe | 56 ppm^{a} Fe | 69 ppm^{a} Fe |
| Fe AAC | 102 ppm^{b} Fe | 114 ppm^{b} Fe | 119 ppm^{b} Fe |

^{a/b}significantly different at P < 0.05

In Table 3 above, it is noted that the iron content where the iron amino acid chelate was used provided better iron tissue retention than any combination that did not use an iron amino acid chelate. Further, by combining the iron amino acid chelate with urea and ammonium nitrate, even better retention of iron was achieved

Greater Fe retention also results in greater plant growth as measured by dry matter. Table 4 summarizes the results.

TABLE 4
Dry Matter

| | 0 ppm N from urea | 500 ppm N from | 1000 ppm N urea |
|---|---|---|---|
| | and ammonium | urea and ammonium | and ammonium |
| | nitrate | nitrate | nitrate |
| FeSO₄ | 13.23 | 15.73 | 14.82 |
| (g/pot) | | | |
| FeEDTA | 14.12 | 15.08 | 11.24 |
| (g/pot) | | | |
| FeAAC | 17.62 | 16.73 | 16.85 |
| (g/pot) | | | |

Table 4 indicates that when there is a higher concentration of nitrogen in the composition, as is the case with the high nitrogen amino acid chelates, total plant production can be enhanced.

### Example 15

A study was conducted in oranges in which the application of zinc nitrate was compared to a zinc mixed ligand amino acid chelate. The mixed ligands included arginine, lysine, histidine, leucine, tryptophan, aspartic acid, alanine, and glycine. Specifically, a 12 year old orchard containing 193 trees per acre was evaluated. The trees were divided into 2 groups. One group was sprayed with a zinc nitrate treatment, and the other group was sprayed with a zinc mixed ligand amino acid chelate treatment. The treatments were applied by a sprayer that sprays 535 gallons of liquid per acre.

Each tree was sprayed twice during the study, a first time at 90% petal drop and a second time 14 days later. The zinc nitrate was applied at 49 ounces per acre and the amino acid chelate at 66 ounces per acre. The amount of zinc applied to each group was equivalent.

Ten trees from each group were selected at random and the oranges picked from those trees by hand. Table 5 gives the summarized results.

TABLE 5

| | | Zn mixed ligand | |
|---|---|---|---|
| | | amino acid | |
| | Zn Nitrate | chelate | % Increase |
| Weight of | 95.11 lbs | 105.84 lbs | 11.3 |
| oranges/tree | | | |
| % Juice | 57.2 | 57.5 | .05 |
| % Brix | 12.2 | 13.3 | 9.0 |
| % Acid | 1.05 | 1.10 | 4.8 |

This study indicates better quality of fruit is derived from trees receiving the high nitrogen-containing zinc amino acid chelate, which is believed to be related to zinc uptake and/or retention. Furthermore, production of the fruit is greater. Both aspects are a function of zinc metabolism within the plant tissue, whether it is in the tree itself or in the fruit.

The zinc nitrate, while having an effect, is a zinc salt. Consequently, when compared to the zinc mixed ligand amino acid chelate, the tissue retention of zinc from the high nitrogen amino acid chelate is greater. This being stated, it is noted that a mixture of the high nitrogen amino acid chelate admixed with zinc nitrate can also produce positive results.

### Example 16

A study was conducted with Golden Delicious apples. Calcium is effective in reducing bitterpit in apples, and the present study was initially designed to determine which source of calcium, described below, had the greatest impact on reducing bitterpit. As a secondary aspect of this study, the leaves and fruit were analyzed to see if the source of calcium could affect calcium retention in the plant tissues.

A block of mature apple trees was divided into 4 sections. Table 6 summarizes the treatment applications.

TABLE 6
Summary of Treatments Applied

| | | | | | Amount Ca |
|---|---|---|---|---|---|
| | Application | | Application | Mineral | Applied per |
| Treatment | Rate | | Frequency | Analysis | Treatment |
| Ca Amino | 64.0 | fl oz/acre | 4 times, | 6.0% Ca | 3.84 oz |
| Acid | (4.7 | L/ha) | 14 day interval | | |
| Chelate | | | | | |
| Ca Nitrate | 64.0 | oz/acre | 4 times, | 8.0% Ca | 5.12 oz |
| | (4.7 | L/ha) | 14 day interval | | |
| Ca Oxide | 6.0 | lb/acre | 4 times, | 30.0% Ca | 28.80 oz |
| | (6.7 | kg/ha) | 14 day interval | | |
| Ca | 4.0 | lb/acre | 4 times, | 35.5% Ca | 22.72 oz |
| Chloride | (4.5 | kg/ha) | 14 day interval | | |

The amino acids in the calcium chelate were glycine, valine, leucine, tryptophan, isoleucine, lysine, aspartic acid, alanine, and arginine. All treatments were made on the same day. The applications began with the first cover spray and continued from there every 14 days for 4 applications. The leaves were collected from a fruiting spur located at a 45 degree angle from the spray rig and into the tree canopy 3 feet. Samples were collected and sent for analysis. Apples were also collected on the same day from the same location as the leaves. They also were sent for analysis of the fruit flesh. The orchard was then harvested and placed in storage. Table 7 summarizes the analytical results.

TABLE 7
Ca Analysis of Apple Leaves and Fruit

| | Leaf Ca | Apple Ca |
|---|---|---|
| Ca Amino Acid Chelate | 2.14% | 201 ppm |
| Ca Nitrate | 2.37% | 190 ppm |
| Ca Oxide | 2.15% | 148 ppm |
| Ca Chloride | 1.70% | 138 ppm |

Both the calcium from the calcium amino acid chelate and the calcium nitrate resulted in greater tissue retention of calcium than did the calcium oxide or calcium chloride. Approximately 33% more calcium from the calcium nitrate source was applied to the leaves than from the calcium amino acid chelate. Thus, one would expect calcium retention in the leaves to be greater in the apple trees that are sprayed with the calcium nitrate compared to calcium amino acid chelate. However, the results in Table 7 clearly show that the calcium retention is similar, even slightly higher in the apples from the amino acid chelate source. Additionally, even though the calcium oxide and chloride applications are substantially higher in overall calcium delivery, the calcium retention from calcium oxide and calcium chloride was not as great as the calcium sources bonded to high N compounds.

Also, the absorbed calcium amino acid chelate was more mobile than the calcium nitrate. Consequently more of the chelated source of calcium moved from the leaves to the apples. Calcium retention in the apples was greatest from the amino acid chelate source.

Greater calcium retention also results in more calcium being available for metabolic purposes in the apples. Consequently the percent of bitterpit in the culls was 14% (Ca amino acid chelate), 20% (Ca nitrate), 25% (Ca oxide), and 26% (Ca chloride). The percent of culls was also less in apples from trees sprayed with calcium amino acid chelate: 31% (Ca amino acid chelate), 34% (Ca nitrate), 34% (Ca oxide), and 36% (Ca chloride). It is noted that absorption of calcium into the plant from a foliar spray is only part of what the plant needs. The calcium source must be able to be retained by the plant after absorption and then be translocated and enter into metabolic activities as needed.

While the invention has been described with reference to certain preferred embodiments, those skilled in the art will appreciate that various modifications, changes, omissions, and substitutions can be made without departing from the spirit of the invention. It is therefore intended that the invention be limited only by the scope of the appended claims.

What is claimed is:

1. An amino acid chelate composition for plant nutrition, comprising:
(a) an amino acid chelate including a first metal and a first amino acid ligand, said first amino acid ligand having at least two nitrogen atoms;
(b) an amino acid complex including a second metal or other ion and a second amino acid ligand, wherein the amino acid complex is different than the amino acid chelate; and
(c) a vehicle or carrier formulated, along with the amino acid chelate and the amino acid complex, which is suitable for delivery to a plant.

2. The amino acid chelate of claim 1, wherein the first amino acid ligand is different than the second amino acid ligand.

3. The amino acid chelate of claim 1, wherein the first metal is different than the second metal or other ion.

4. The amino acid chelate composition of claim 1, wherein the amino acid complex is also an amino acid chelate.

5. The amino acid chelate composition of claim 1, wherein the first amino acid ligand includes an amino acid selected from the group consisting of arginine, asparagine, glutamine, histidine, lysine, ornithine, cystine, and tryptophan, including dipeptides, tripeptides, and tetrapeptides thereof.

6. The amino acid chelate composition of claim 1, wherein the second amino acid ligand includes an amino acid selected from the group consisting of alanine, arginine, asparagine, aspartic acid, cysteine, cystine, glutamine, glutamic acid, glycine, histidine, hydroxyproline, isoleucine, leucine, lysine, methionine, ornithine, phenylalanine, proline, serine, threonine, tryptophan, tyrosine, and valine, including dipeptides, tripeptides, and tetrapeptides thereof.

7. The amino acid chelate composition of claim 1, wherein the first metal is selected from the group consisting of copper, zinc, manganese, iron, calcium, boron, silicon, magnesium, cobalt, nickel, and molybdenum; and the second metal or other ion is selected from the group consisting of copper, zinc, manganese, iron, calcium, potassium, phosphorous, boron, sodium, silicon, magnesium, cobalt, nickel, and molybdenum.

8. The amino acid chelate composition of claim 1, wherein the first metal and second metal or other ion are the same, and the first and second amino acid ligands are different.

9. The amino acid chelate composition of claim 1, wherein the first metal and second metal or other ion are different, and the amino acid ligands are different.

10. The amino acid chelate composition of claim 1, wherein the first metal and second metal or other ion are different, and the first and second amino acid ligands are the same.

11. The amino acid chelate composition of claim 1, wherein the first amino acid ligand includes at least three nitrogen atoms.

12. The amino acid chelate composition of claim 1, wherein the first amino acid ligand includes at least four nitrogen atoms.

13. The amino acid chelate composition of claim 1, wherein the second amino acid ligand includes at least two nitrogen atoms.

14. The amino acid chelate composition of claim 1, wherein the first amino acid chelate and the second amino acid complex each have an amino acid ligand to metal ratio from about 1:1 to about 4:1.

15. The amino acid chelate composition of claim 1, wherein the amino acid chelate composition has a first amino acid chelate to second amino acid complex ratio from about 10:1 to about 1:10.

16. The amino acid chelate composition of claim 1, further comprising a third nitrogen-containing compound.

17. The amino acid chelate composition of claim 16, wherein the third nitrogen-containing compound is selected from the group consisting of nitrogen-containing salts, proteinates, urea, nitric acid, ammonium nitrate, hydrolyzed animal sourced or plant sourced proteins, and combinations thereof.

18. The amino acid chelate composition of claim 1, wherein the composition comprises a source of potassium, phosphorus, or iron.

19. The amino acid chelate composition of claim 1, wherein the nitrogen content from the amino acid chelate and amino acid complex is from about 5 wt % to about 35 wt %.

20. The amino acid chelate composition of claim 1, wherein the composition is formulated for delivery to the plant leaves or flowers.

21. The amino acid chelate composition of claim 1, wherein the composition is formulated for delivery to plant roots.

22. The amino acid chelate composition of claim 1, wherein the composition is formulated for delivery to plant seeds.

23. The amino acid chelate composition of claim 1, wherein the composition is formulated as liquid.

24. The amino acid chelate composition of claim 1, wherein the composition is formulated as a solid.

25. The amino acid chelate composition of claim 1, wherein the composition comprises hydrolyzed blood meal, hydrolyzed manure, hydrolyzed fish emulsions, worm castings, hydrolyzed alfalfa meal, or hydrolyzed cotton seed meal.

26. An amino acid chelate composition for plant nutrition, comprising:
(a) an amino acid chelate including a metal and an amino acid ligand having at least two nitrogen atoms;
(b) a second nitrogen-containing compound selected from the group consisting of nitrogen-containing salts, proteinates, urea, nitric acid, ammonium nitrate, hydrolyzed animal sourced or plant sourced proteins, and combinations thereof; and
(c) a vehicle or carrier formulated, along with the amino acid chelate and the second nitrogen-containing compound, which is suitable for delivery to a plant.

27. The amino acid chelate composition of claim 26, wherein the metal is selected from the group consisting of copper, zinc, manganese, iron, calcium, boron, silicon, magnesium, cobalt, nickel, and molybdenum.

28. The amino acid chelate composition of claim 26, wherein the composition comprises a source of potassium, phosphorus, or iron.

29. The amino acid chelate composition of claim 26, wherein the amino acid ligand includes an amino acid selected from the group consisting of arginine, asparagine, cystine, glutamine, histidine, lysine, ornithine, cystine, and tryptophan, including dipeptides, tripeptides, and tetrapeptides thereof.

30. The amino acid chelate composition of claim 26, wherein the second nitrogen-containing compound is a proteinate.

31. The amino acid chelate composition of claim 26, wherein the second nitrogen-containing compound is urea.

32. The amino acid chelate composition of claim 26, wherein the second nitrogen-containing compound is nitric acid.

33. The amino acid chelate composition of claim 26, wherein the second nitrogen-containing compound is a nitrogen-containing salt.

34. The amino acid chelate composition of claim 26, wherein the second nitrogen-containing compound includes at least two nitrogen atoms.

35. The amino acid chelate composition of claim 26, wherein the amino acid ligand includes at least three nitrogen atoms.

36. The amino acid chelate composition of claim 26, wherein the amino acid ligand includes at least four nitrogen atoms.

37. The amino acid chelate composition of claim 26, wherein the nitrogen content from the amino acid chelate and second nitrogen-containing compound is from about 5 wt % to about 35 wt %.

38. The amino acid chelate composition of claim 33, wherein the nitrogen-containing salt includes a second metal or other ion and an anionic counterion.

39. The amino acid chelate composition of claim 38, wherein the second metal or other ion is independently selected from the group consisting of copper, zinc, manganese, iron, calcium, potassium, phosphorous, boron, sodium, silicon, magnesium, cobalt, nickel, and molybdenum.

40. The amino acid chelate composition of claim 38, wherein the metal and the second metal or other ion are the same.

41. The amino acid chelate composition of claim 38, wherein the metal and the second metal or other ion are different.

42. The amino acid chelate composition of claim 38, wherein the anionic counterion is selected from the group consisting of nitrates, amino acid sulfates, and ureates.

43. The amino acid chelate composition of claim 26, wherein the composition is formulated for delivery to the plant leaves or flowers.

44. The amino acid chelate composition of claim 26, wherein the composition is formulated for delivery to plant roots.

45. The amino acid chelate composition of claim 26, wherein the composition is formulated for delivery to plant seeds.

46. The amino acid chelate composition of claim 26, wherein the composition is formulated for delivery to fruit.

47. The amino acid chelate composition of claim 26, wherein the composition is formulated as liquid.

48. The amino acid chelate composition of claim 26, wherein the composition is formulated as a solid.

49. The amino acid chelate composition of claim 26, wherein the composition comprises hydrolyzed blood meal, hydrolyzed manure, hydrolyzed fish emulsions, worm castings, hydrolyzed alfalfa meal, or hydrolyzed cotton seed meal.

50. A method of increasing a metabolic activity in plant tissue, comprising delivering an amino acid chelate composition including an amino acid chelate having a multi-nitrogen-containing amino acid ligand and a metal to a plant in an amount sufficient to i) raise the nitrogen and the metal concentration within the tissue, ii) retain metal content in the tissue for a greater period of time compared to when the metal is delivered as a compound with less nitrogen, and iii) enhance metabolic activity of the tissue.

51. The method of claim 50, wherein the multi-nitrogen-containing amino acid ligand includes an amino acid selected from the group consisting of arginine, asparagine, cystine, glutamine, histidine, lysine, ornithine, and tryptophan, including dipeptides, tripeptides, and tetrapeptides thereof.

52. The method of claim 50, wherein the multi-nitrogen-containing amino acid ligand includes at least three nitrogen atoms.

53. The method of claim 50, wherein the multi-nitrogen-containing amino acid ligand includes at least four nitrogen atoms.

54. The method of claim 50, wherein the nitrogen content from the amino acid chelate is from about 5 wt % to about 35 wt %.

55. The method of claim 50, including co-delivering a second amino acid chelate that is different than the amino acid chelate, said second amino acid chelate including a second metal and a second amino acid ligand.

56. The method of claim 55, wherein the second amino acid ligand includes an amino acid selected from the group consisting of alanine, arginine, asparagine, aspartic acid, cysteine, cystine, glutamine, glutamic acid, glycine, histidine, hydroxyproline, isoleucine, leucine, lysine, methionine, ornithine, phenylalanine, proline, serine, threonine, tryptophan, tyrosine, and valine, including dipeptides, tripeptides, and tetrapeptides thereof.

57. The method of claim 55, wherein the metal and the second metal are independently selected from the group consisting copper, zinc, manganese, iron, calcium, boron, silicon, magnesium, cobalt, nickel, and molybdenum.

58. The method of claim 55, wherein the metal and the second metal are the same, and the multi-nitrogen-containing amino acid ligand and the second amino acid ligand are different.

59. The method of claim 55, wherein the metal and the second metal are different, and the multi-nitrogen-containing amino acid ligand and the second amino acid ligand are different.

60. The method of claim 55, wherein the metal and the second metal are different, and the multi-nitrogen-containing amino acid ligand and the second amino acid ligand are the same.

61. The method of claim 55, wherein the second amino acid ligand includes at least two nitrogen atoms.

62. The method of claim 55, wherein the amino acid chelate and the second amino acid chelate each have an amino acid ligand to metal ratio from about 1:1 to about 4:1.

63. The method of claim 55, wherein the amino acid chelate composition has an amino acid chelate to second amino acid chelate weight ratio from about 10:1 to about 1:10.

64. The method of claim 50, including co-administering a nitrogen-containing non-chelate salt including a second metal or other ion and an anionic counterion.

65. The method of claim 64, wherein the first metal is selected from the group consisting of copper, zinc, manganese, iron, calcium, boron, silicon, magnesium, cobalt, nickel, and molybdenum; and the second metal or other ion is selected from the group consisting of copper, zinc, manganese, iron, calcium, potassium, phosphorous, boron, sodium, silicon, magnesium, cobalt, nickel, and molybdenum.

66. The method of claim 64, wherein the metal and the second metal or other ion are the same.

67. The method of claim 64, wherein the metal and the second metal or other ion are different.

68. The method of claim 64, wherein the anionic counterion is selected from the group consisting of nitrates, amino acid sulfates, and ureates.

69. The method of claim 50, including co-administering a second nitrogen-containing compound.

70. The method of claim 69, wherein the second nitrogen-containing compound includes at least two nitrogen atoms.

71. The method of claim 69, wherein the second nitrogen-containing compound is selected from the group consisting of nitrogen-containing salts, proteinates, urea, nitric acid, ammonium nitrate, hydrolyzed animal sourced or plant sourced proteins, and combinations thereof.

72. The method of claim 69, wherein the second nitrogen-containing compound comprises hydrolyzed blood meal, hydrolyzed manure, hydrolyzed fish emulsions, worm castings, hydrolyzed alfalfa meal, or hydrolyzed cotton seed meal.

73. The method of claim 69, wherein the nitrogen content from the amino acid chelate and second nitrogen-containing compound is from about 5 wt % to about 35 wt %.

74. The method of claim 50, wherein the step of delivering is foliar.

75. The method of claim 50, wherein the step of delivering is by delivery to soil immediately adjacent a plant or seed.

76. The method of claim 50, wherein the step of delivering is to plant roots.

77. The method of claim 50, wherein the step of delivering is to a seed.

78. The method of claim 50, wherein the step of delivering is to a fruit.

79. The method of claim 50, wherein the amino acid chelate composition is formulated as a solid.

80. The method of claim 50, wherein the amino acid chelate composition is formulated as a liquid.
